(19) United States
(12) Patent Application Publication
(10) Pub. No.: US 2026/0098389 A1
(43) Pub. Date: Apr. 9, 2026

(54) HEATED SNOW SHOVEL AND RELATED METHODS

(71) Applicant: William James Pearson, Lithia, FL (US)

(72) Inventor: William James Pearson, Lithia, FL (US)

(21) Appl. No.: 19/245,674

(22) Filed: Jun. 23, 2025

Related U.S. Application Data
(60) Provisional application No. 63/704,203, filed on Oct. 7, 2024.

(51) Int. Cl. E01H 5/10; E01H 5/02; H05B 3/00

(52) U.S. Cl. CPC E01H 5/10; E01H 5/02; H05B 3/0004

(57) ABSTRACT

A snow shovel including a shaft extending longitudinally from a proximal end to a distal end, a handle connected to the proximal end of the shaft, a battery connected to the shaft, a shovel head connected to the distal end of the shaft, and a scraper blade removably connected to the shovel head and extending outwardly therefrom. The blade is eclectically coupled to the battery such that the blade is selectively heatable by the battery and configured to contact and heat snow.

### CROSS-REFERENCE TO RELATED APPLICATION

This is a regular utility of provisional application No. 63/704,203, filed on Oct. 7, 2024, the contents of which are expressly incorporated herein by reference.

### FIELD OF ART

The present disclosure is generally directed to snow shovels, and more particularly to systems and methods for a heated snow shovel.

### BACKGROUND

Heated snow shovels make the process of shoveling snow far easier as the heat emanating from the shovel helps to dislodge the snow from the ground. Generally, a heated snow shovel includes a shaft, a handle, and a heated shovel head. The shovel head is typically heated by a corded electrical heating element which is internally disposed within an internal cavity of the shovel head. Such prior art heated snow shovels can be cumbersome to maneuver as the electrical cord may become tangled or limit movement of the snow shovel. Furthermore, due to the physical structure and placement of the heating element within the shovel head, the shovel head may be unevenly heated, having hotter or cooler areas thereon which may turn the snow to slush or liquid that is subsequently refrozen by the surrounding cold air and which may then create a buildup of ice and debris on the shovel head or otherwise damage the electrical components of the snow shovel.

### SUMMARY

Broadly speaking, aspects of the invention are directed to a snow shovel with a heatable scraper blade. The snow shovel generally includes a shaft, one or more handles connected to the shaft, a battery or other power source, a shovel head connected to the shaft and comprised of a non-conductive material, and a scraper blade connected to the shovel head and electrically connected to the battery or other power source. The scraper blade is comprised of a conductive material such that upon receiving electrical power at the behest of the user, the electrical resistance of the scraper blade, as the current flows through the scraper blade, generates heat to melt or otherwise heat the snow being shoveled by the user. Upon connecting the scraper blade to the shovel head, the scraper blade is automatically electrically coupled the battery or other power source via internally disposed electrical wiring and terminals. Additionally, the scraper blade is easily removable and replaceable as desired if the scraper blade becomes dull or otherwise damaged.

Aspects of the invention include a heated snow shovel. The heated snow shovel including a shaft extending longitudinally from a proximal end to a distal end, a handle connected to the proximal end of the shaft, and a battery connected to the shaft. The heated snow shovel further including a shovel head connected to the distal end of the shaft, and a scraper blade removably connected to the shovel head and extending outwardly therefrom. The blade is eclectically coupled to the battery such that the blade is selectively heatable by the battery and configured to contact and heat snow.

In one embodiment, the battery is configured to only heat the blade such that only the blade is configured to heat the snow.

In one embodiment, the shovel head comprises a non-conductive material, and the blade comprises a conductive material, allowing the blade to become heated upon receiving electrical power from the battery.

In one embodiment, the snow shovel further includes a blade compartment at a distal end of the shovel head and a first and a second terminal respectively mounted on opposing sides of the blade compartment. The snow shovel further includes electrical wiring extending in between the battery and the first and second terminals. The blade automatically contacts the first and second terminals, and therewith becomes electrically coupled to the battery, upon being seated within the blade compartment.

In one embodiment, the shovel head comprises a blade compartment at a distal end thereof, and the blade is seated within the blade compartment such that a top surface of the blade is substantially flush with a top surface the shovel head.

In one embodiment, the blade compartment of the shovel head comprises a vertical end wall and a shelf extending outwardly and substantially perpendicularly from the end wall which is configured to at least partially support the blade when the blade is seated within the blade compartment.

In one embodiment, the shovel head comprises a multipart blade compartment at a distal end thereof. The multipart blade compartment comprises a top wall, a bottom wall, and a vertical end wall extending in between the top wall and the bottom wall. The top wall, the bottom wall, and the end wall collectively define an open recess within which the blade is removably seated.

In one embodiment, the blade comprises one or more detents. The blade compartment comprises one or more detent recesses corresponding to the one or more detents of the blade, allowing the blade to be removable upon pulling outwardly on the blade to overcome a detent force of the one or more detents acting against the blade compartment.

In one embodiment, the snow shovel further includes an attachment plate connected to the shovel head and electrically coupled to the battery. The attachment plate is configured to at least partially extend over and secure the blade onto the shovel head. The battery is configured to selectively and simultaneously heat both the of the blade and the attachment plate.

In one embodiment, the blade comprises a steel shell and a nichrome core disposed within the steel shell.

In one embodiment, the blade comprises a multipart blade including two or more individually heated sections removably connected to the shovel head.

In one embodiment, the snow shovel further includes a user input device connected to the shaft and electrically coupled to the battery. The user input device is configured to receive user input to selectively provide electrical power from the battery to the blade for heating the blade.

Aspects of the invention also include a snow shovel. The snow shovel includes a shaft, a heating device, a shovel head connected to the shaft, and a scraper blade removably connected to the shovel head and extending outwardly therefrom. The blade is eclectically coupled to the heating device such that the blade is selectively heatable by the heating device and configured to contact and heat snow.

In one embodiment, the snow shovel further includes a first handle connected to the shaft at a proximal end thereof and a second handle connected to the shaft at an approximate midpoint thereof. The first handle and/or the second handle comprise a user input device mounted thereon and which is operably coupled to the heating device.

Aspects of the invention also include a method of making a snow shovel. The method includes forming a snow shovel. The snow shovel is configured to heat snow. The snow shovel includes a shaft, a heating device, a shovel head connected to the shaft, and a scraper blade removably connected to the shovel head and extending outwardly therefrom. The blade is eclectically coupled to the heating device. The heating device is configured to only heat the blade so that only the blade is configured to heat the snow.

In one embodiment, the method further includes a step of replacing the blade by decoupling the blade from a blade compartment of the shovel head and inserting a differing second blade into the blade compartment. The second blade is automatically electrically coupled to the heating device upon insertion into the blade compartment.

### BRIEF DESCRIPTION OF THE DRAWINGS

These and other features and advantages of the present devices, systems, and methods will become appreciated as the same becomes better understood with reference to the specification, claims and appended drawings wherein:

FIG. 1 is a top perspective view of a heated snow shovel, which generally includes a handle, a shaft, a heating device, a shovel head, and a removable and heated scraper blade, according to an exemplary embodiment.

FIG. 2 is a schematic and cross-sectional view of the heated snow shovel of FIG. 1.

FIG. 3 is a schematic and isolation view of a multilayered scraper blade, according to an exemplary embodiment.

FIG. 4 is a top perspective view of another heated snow shovel including an attachment plate securing a removable scraper blade onto a shovel head, according to another exemplary embodiment.

FIG. 5 is a schematic and cross-sectional view of the heated snow shovel of FIG. 4.

FIG. 6 is a top perspective view of another heated snow shovel including a multi-section scraper blade composed of individually heated scraper blade sections, according to another exemplary embodiment.

### DETAILED DESCRIPTION

The detailed description set forth below in connection with the appended drawings is intended as a description of the presently preferred embodiments of snow shovels, in accordance with aspects of the present devices, systems, and methods, and is not intended to represent the only forms in which the present devices, systems, and methods may be constructed or utilized. The description sets forth the features and the steps for constructing and using the embodiments of the present devices, systems, and methods in connection with the illustrated embodiments. It is to be understood, however, that the same or equivalent functions and structures may be accomplished by different embodiments that are also intended to be encompassed within the spirit and scope of the present disclosure. As denoted elsewhere herein, like element numbers are intended to indicate like or similar elements or features.

Descriptions of technical features or aspects of an exemplary configuration of the disclosure should typically be considered as available and applicable to other similar features or aspects in another exemplary configuration of the disclosure. Accordingly, technical features described herein according to one exemplary configuration of the disclosure may be applicable to other exemplary configurations of the disclosure, and thus duplicative descriptions may be omitted herein.

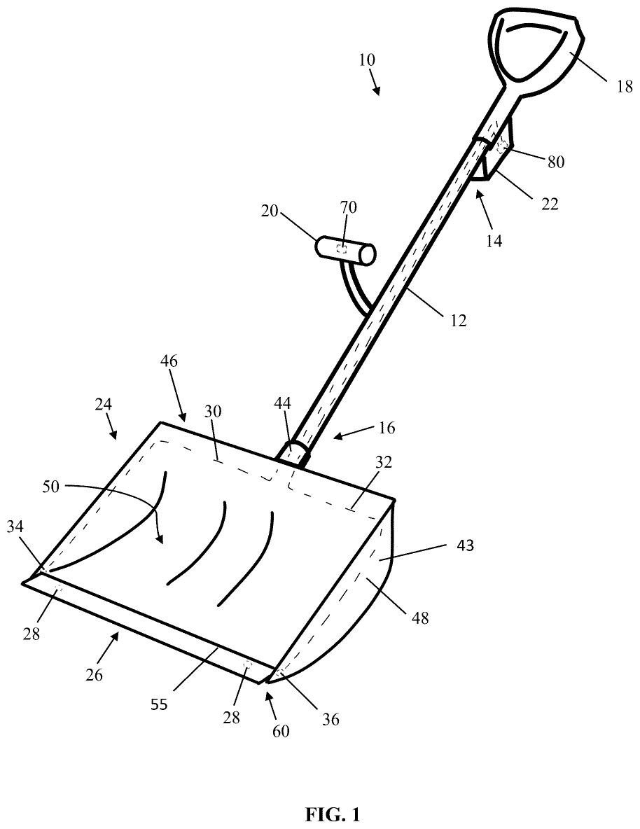

As used herein, terms like front or forward, back or rearward, top, and bottom are defined relative to the heated snow shovel, as shown in FIG. 1. The proximal or top end of the snow shovel generally refers to the portion of the snow shovel that is closest to the user during use thereof when shoveling snow or other material. The distal or bottom end of the snow shovel generally refers to the portion of the snow shovel that is closest to the ground (furthest from the body of the user) during use thereof when shoveling snow or other material. Where the terms first, second, third, etc. are used, they meant to distinguish by reference number only, but not necessarily structurally limiting unless the context indicates otherwise.

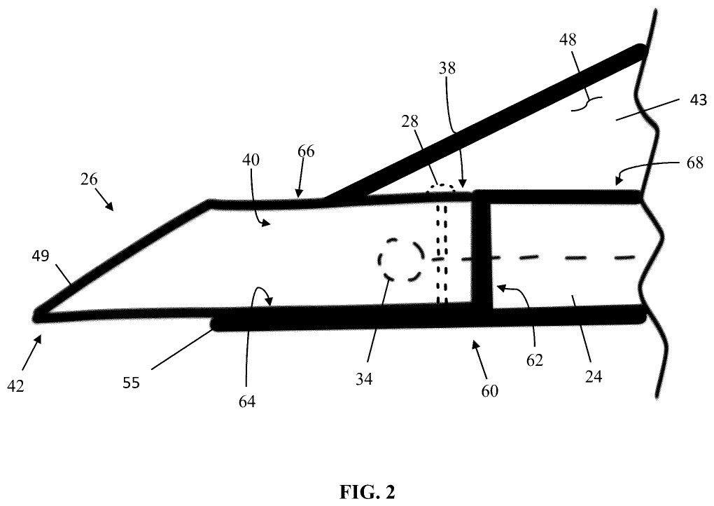

FIGS. 1-2 illustrate an embodiment of a heated snow shovel 10 for shoveling and simultaneously heating snow (or other material, e.g., sleet, ice, etc.), in accordance with aspects of the invention. The snow shovel 10 may generally include a shaft 12 extending longitudinally from a proximal end 14 to a distal end 16, one or more handles 18, 20 connected to the shaft 12, a heating device 22, in the form of an energy source or a battery, connected to the shaft 12, a shovel head 24 connected to the distal end 16 of the shaft 12, and a heated scraper blade 26 removably connected to the shovel head 24 via one or more fasteners 28, such as bolts or screws.

The shovel head 24 may have a distal edge 55 and the blade 26 may extend outwardly from the distal edge of the shovel head 24 and define a distal end or active end (or a first point of contact) of the snow shovel 10. The blade 26 can have side edges, positioned at two ends of the distal edge of the blade, that extend laterally towards the two sidewalls 48 of the body 43 of the shovel head 24. In some examples, the two side edges of the blade contact or nearly contact the two sidewalls 48. The blade 26 may be eclectically coupled to the battery 22 via internal electrical wiring 30, 32 (e.g., positive and negative lead wires 30, 32) and electrical terminals 34, 36 mounted on the shovel head 24, as discussed in more detail further herein. The shovel head 24 may be comprised of a non-conductive material, such as plastic, and the blade 26 may be comprised of a conductive material, such as steel, allowing the blade 26 to become heated upon receiving electrical power, e.g., DC current, from the battery 22. In more detail, the electrical resistance of the blade 26, as the current flows through the blade 26, may cause the blade 26 to become heated to melt snow when scraping the blade 26 against the ground. At a minimum, the heated active end or distal edge that is part of the blade 26 is configured to at least partially melt or change the solid phase of the outer-most layers of the snow or ice to facilitate breaking up of the ice and/or snow to be shoveled. By affecting the outer-most layers of the snow or ice, it is believed that the snow or ice can readily crack and propagates along the cracks to facilitate scooping by the user.

In one embodiment, only the blade 26 is heated by the battery 22, and therein the shovel head 24 may be an unheated shovel head 24, which does not receive current from, or is otherwise heated by, the battery 22. In this example, the snow shovel 10 only heats the snow at a distal end or contact edge, defined by the blade 26. Since the snow may be heated at its initial point of contact with the snow shovel 10, such as being contacted by the outer layers by the heated blade 26, the change in the snow structure of the outer layers may initiate further breakups upon being physically broken by the user to readily and easily remove the snow from the ground as the user scrapes the blade 26 against the ground, without further melting (or otherwise heating) the snow when the snow rests within the shovel head 24. Thereby, in some embodiments, the shovel head 24 may not need to further heat the snow (keeping the snow frozen whilst on the shovel head 24) but still assists the user in the shoveling task, which will accordingly minimize power consumption and unnecessary melting of snow into slush and/or liquid that is more difficult to contain. Further, liquefied snow can increase the risk of corroding the electrical components, e.g., terminals 34, 36, and/or cause a buildup of refrozen ice or debris on the shovel head 24.

In an example, the blade 26 may comprise a blunt proximal end 38, which can abut a wall or shoulder in the shovel head 24. As shown, the blunt proximal end is a squared end. The blade 26 further includes a middle section 40 and a tapered distal end 42, which extends outwardly beyond the distal edge 55 of the shovel head 24 (FIG. 2), and defines a blade edge 49 having a tip. The tip of the blade edge can be the distal-most structure located on the snow shovel. This allows the tip to break or cut into the ice and/or snow first before other parts of the shovel head. However, the blade 26 may comprise other desired shapes and sizes aside from the configuration shown. The distal edge 55 of the blade 26 is perpendicular arranged to the longitudinal axis of the shaft 12. In an alternative embodiment, the blade 26 may comprise a lip at its proximal end which extends rearwardly and over the top of the shovel head 24 when the blade 26 is connected to the shovel head 24 to alter the interface between the blade 26 and the shovel head 24 as a design consideration for the direction of force when shoveling ice and/or snow. In another alternative embodiment, the blade 26 may be mounted on top of the shovel head 24 instead of in a slot or a channel, as examples.

In one embodiment, the shaft 12 may comprise a tubular shaft 12 with one or more internal wiring channels for housing the electrical wires 30, 32. The shaft 12 may comprise any desired material, such as metal, plastic, composites, or combinations thereof. In one embodiment, the snow shovel 10 may include only one handle 18 connected to the proximal end 14 of the shaft 12. In one embodiment, the snow shovel 10 may include two or more handles, including a first handle 18 connected to the proximal end 14 of the shaft 12 and a second handle 20 connected to an approximate midpoint of the shaft 12 (e.g., plus or minus one quarter of the length of the shaft 12 from its midpoint). The first handle 18 may comprise a looped or closed handle, and the second handle 20 may comprise a ball or bar-like handhold extending outwardly form the shaft 12. Each handle 18, 20 may comprise any desired material, such as plastic, wood, composites or combinations thereof.

In one embodiment, the battery 22 may be connected to the shaft 12 at or near its proximal end 14, counterbalancing the weight of the shovel head 24. In a less preferred embodiment, the battery 22 can be connected to the shaft 12 at another location, such as the distal end 16 of the shaft 12. In one embodiment, the battery 22 may comprise a rechargeable lithium ion battery 22 which can be removably connected to a battery mount on the shaft 12. The battery mount can be a casing or housing having a battery connector for receiving the battery with similarly arranged contacts. The battery mount can be provided with vibration absorbers. For example, springs and gaskets can be liberally used with the battery mount so that when the shovel impacts the ice and/or the snow, the recoil or vibrations caused by the impact is dampened by the springs and/or gaskets.

An on/off switch may be provided to complete the circuit to send current from the battery to the blade. The on/off switch can be provided at the battery mount or elsewhere on the snow shovel, such as near the handle 18 or handle 20. In other examples, a trigger switch is incorporated to complete the circuit rather than an on/off switch. The trigger switch can be located at the handle 18 or handle 20 so that the trigger switch can be pressed by the user during the shoveling choir. The battery may be removable for recharging, similar to a battery operated cordless drill. The battery 22 may supply DC current to the blade 26 via the electric wires 30, 32. In one embodiment, the electrical wires 30, 32 can be disposed within respective channels within the shaft 12 and the shovel head 24. By routing the electrical wires 30, 32 in a common channel or in multiple channels, the wires can be hidden from view and exposure and be less prone to damage.

The shovel head 24 may include a mating portion 44, e.g., a protrusion 44 with an annular recess therein, such as a female coupling, for mating with the distal end 16 of the shaft 12. A set screw or similar retention fasteners may be used to retain the shaft within the coupling 44. In one embodiment, the shovel head 24 comprises a body 43 with a top wall 46, a pair of side walls 48, and a bottom wall 50. The body has a generally rectangular profile, the side walls can be shaped, such as being tapered, and the bottom wall can be concave instead of flat to define a deep holding space for shoveling ice and/or snow. However, the shovel head 24 may comprise any desired shape, such as a spade, square, etc. The shovel head 24 may comprise any desired material, such as a non-conductive material or composition of materials with at least one non-conductive material therein which separates the blade 26 from the other body 43 of the shovel head 24. In one embodiment, the shovel head 24 may be composed of plastic, which can be of any variety of durable plastics or engineered plastics. In another embodiment, the shovel head 24 may be composed of aluminum or an aluminum alloy. In one embodiment, the shovel head 24 may further include one or more ribs to increase its rigidity. When the body is made of a metal material, such as aluminum or aluminum alloy, the interface between the blade 26 and the body 43 should be include a non-conductive divider or spacer to isolate the blade from the body.

The shovel head 24 may further include a blade compartment 60 at a distal end of the shovel head 24. The blade compartment 60 may receive and mount the blade 26 on the shovel head 24. In one embodiment, the blade compartment 60 is defined by the body 43 of the shovel head 24. In an alternative embodiment, the blade compartment 60 may comprise a separate component affixed to the body 43 of the shovel head 24. By way of example only, as shown in FIG. 2, the blade compartment 60 may generally include a vertical end wall 62 and a shelf 64 extending outwardly and substantially perpendicularly from the end wall 62. The shelf 64 is configured to at least partially support the blade 26 when the blade 26 is seated within the blade compartment 60. Once seated within the blade compartment 60, a top surface 66 of the blade 26, which is exposed, may be substantially flush with a top surface 68 the shovel head 24, which is located proximally of the blade. In other examples, the blade compartment 60 can include a top surface that extends distally to cover part of the top surface 66 of the blade 26. In this alterative embodiment, the extended part of the blade compartment 60 in combination with the end wall 62 and the shelf 64 define a holding cavity for receiving the blade 26. The one or more fasteners 28 can project through corresponding bores formed through the extended part to secure the blade in place within the holding cavity.

In one embodiment, the electrical terminals 34, 36 may be electrically connected to the electrical wires 30, 32 and mounted or integrated into the blade compartment 60 of the shovel head 24. Since the terminals 34, 36 are integrated into the blade compartment 60, the blade 26 automatically contacts the terminals 34, 36, and becomes electrically coupled to the battery 22, upon being seated within the blade compartment 60. Each electrical terminal 34, 36 may comprise an exposed conductive material, such as a copper receptacle, leaf spring, prongs, or other contact point, which directly engages or abuts with the blade 26 upon assembly of the blade into the blade compartment 60. The electrical terminals 34, 36 may be positioned at any desired location on the shovel head 24, so long as the electrical terminals contact and/or are secured to the blade 26. For example, in one embodiment as shown in FIG. 2, each electrical terminal 34, 36 may be respectively connected to a side wall 48 of the shovel head 24 (only one electrical terminal 34 is shown in phantom in the cross-sectional view of FIG. 2). In other words, a first terminal 34 can be mounted on a first side of the blade compartment 60 (or left side wall 48 of the shovel head 24) and a second terminal 36 can be mounted on an opposing, second side of the blade compartment 60 (or a right side wall 48 of the shovel head 24). In an alternative embodiment, each electrical terminal 34, 36 may be mounted on the vertical end wall 62 or the bottom shelf 64 of the blade compartment 60 of the shovel head 24.

In one embodiment, each electrical terminal 34, 36 may apply a clamping or holding force onto the blade 26, which secures the blade 26 onto the shovel head 24. For instance, the snow shovel 10 may include multipurpose mounting brackets with integrated electrical terminals (not shown). In an example, the blade 26 may be mounted onto the shovel head 24 via a left and right pair of blade mounting brackets at the left and right side walls 48 of the shovel head 24. Each blade mounting bracket may also integrally house a respective electrical terminal 34, 36. Each mounting bracket may include a vertical wall and at least one clamp member that extends over the blade 26 for securing the blade 26 against the shovel head 24. A protective covering may extend over each mounting bracket to shield the mounting bracket from damage when using the snow shovel 10. In such an embodiment, the snow shovel 10 may or may not include blade fasteners 28 for securing the blade 26 to the shovel head 24.

In one embodiment, the snow shovel 10 further includes a user input device 70 connected to the shaft 12 and operably coupled to the battery 22. The user input device 70 is configured to receive user input to selectively provide electrical power from the battery 22 to the blade 26 for heating the blade 26. For example, the user may manipulate the user input device 70 as desired to selectively and adjustably heat the blade 26 (e.g., via selecting one or more adjustable heat settings or temperature ranges). One or more user input devices 70 may be mounted on the first and/or second handles 18, 20, the shaft 12, and/or a battery housing if equipped. In one embodiment, as shown in FIG. 1, the user input device 70 may be mounted on the second handle 20. Each user input device 70 may comprise a mechanical switch, dial, button(s), and/or display screen. Each user input device 70 may be operably coupled to the battery 22 by a wired or wireless connection. In an example, the input device is an on/off switch. In another example, the input device is a potentiometer that can be used to adjust voltage output to the circuit to vary the current traveling to the blade 26.

In one embodiment, the snow shovel 10 may further comprise a control unit 80 for automatically turning on and off the electrical power to heat the blade 26. In one embodiment, the control unit 80 may comprise a controller, e.g., a memory and one or more hardware processors, and a timer which collectively serve to turn on and off electrical current to the blade 26 at certain time intervals. In another embodiment, the control unit 80 may further include one or more sensors (not shown), e.g., temperature sensors, operably coupled to the controller and mounted at the distal end of the shovel head 24 to sense the temperature of the blade 26. The controller in combination with the sensor(s) may maintain the blade 26 at a desired present temperature, such as 100 degrees Fahrenheit, plus or minus 50 degrees. In an alternative embodiment, the snow shovel 10 may not include a control unit 80.

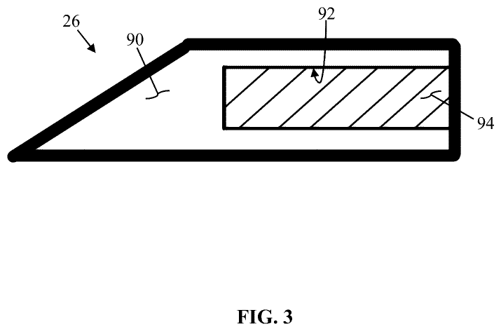

FIG. 3 illustrates another embodiment of a scraper blade 26, wherein the scraper blade 26 is comprised of two or more materials, including at least one conductive material. For instance, as shown by way of example only in FIG. 3, the blade 26 may comprise a steel portion 90, comprised of steel shell with an open recess or cavity 92 therein, and an inner nichrome core 94 fitted within the cavity 92. Alternatively, the steel portion 90 may comprise two or more layers surrounding the nichrome core 94. The nichrome core 94 may have a higher electrical resistance than the steel portion 90, and thereby the nichrome core 94 may become heated faster than the steel portion 90 to help heat the entirety of the blade 26 faster as opposed to a blade 26 comprised only of steel. Also, since steel is generally harder than nichrome, the steel portion 90 may help protect the nichrome core 94 from becoming damaged. However, in an alternative embodiment, the blade 26 may be comprised of only one conductive material, such as steel.

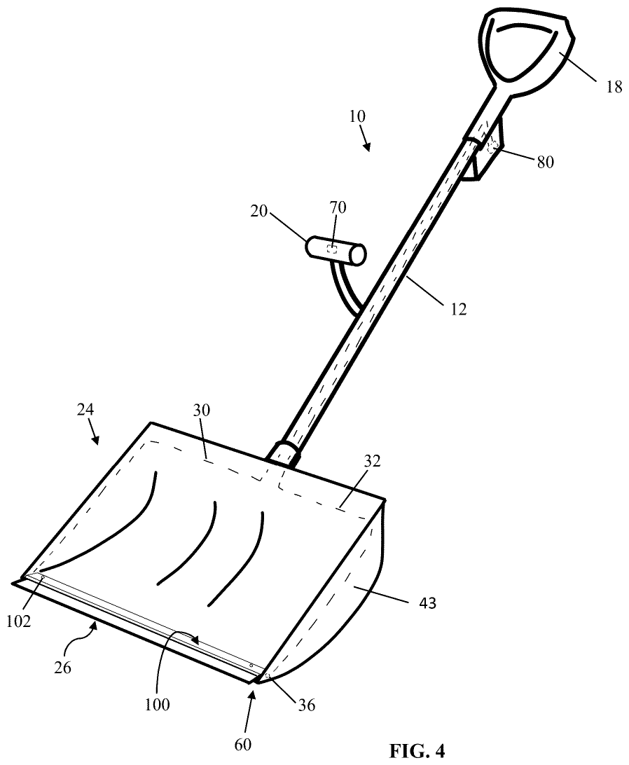

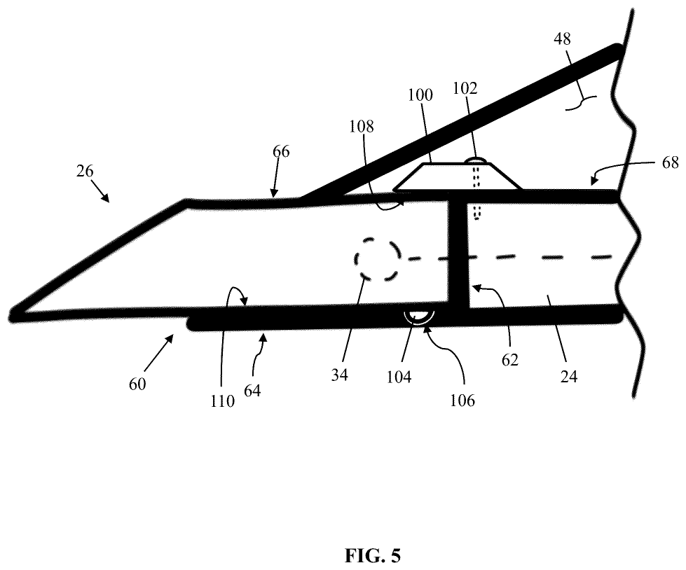

FIGS. 4-5 illustrate another exemplary embodiment of a snow shovel 10. The snow shovel 10 may be substantially similar to the snow shovel 10 as discussed above with respect to FIGS. 1-2 with a few alternative or changes. In an example, the alternative snow shovel 10 of FIGS. 4-5 includes a multipart blade compartment 60 formed by the body 43 of the shovel head 24 and a removable attachment plate 100 removably connected to the shovel head 24 via one or more fasteners 102, e.g., bolts, screws, etc. (as shown in phantom in FIG. 5). Additionally, the blade 26 may be removably connected to the blade compartment 60, and more particularly to the bottom shelf 64, by one or more detents 104 and corresponding detent recesses 106. Like elements have been identified with like reference characters.

In one embodiment, the snow shovel 10 may include the attachment plate 100 to help secure the blade 26 and/or heat the snow in conjunction with the blade 26. The attachment plate 100 may extend over a portion of the shovel head 24 and a portion of the blade 26, therein covering a seam (or connection point) between the blade 26 and the shovel head 24. In other words, the attachment plate 100 may at least partially extend over the blade 26 and the shovel head 24 to cover the connection thereof. The attachment plate 100 may be comprised of a conductive material, such as steel and/or nichrome. The attachment plate 100 may comprise a differing material than the blade 26. The attachment plate 100 may be electrically connected to and heated by the battery 22, by nature of being comprised of a conductive material and contacting the blade 26. In one embodiment, the attachment plate 100 may become heated from the heat emanating from the blade 26 and/or from the electrical resistance of current passing through the attachment plate 100 (via initially flowing through the blade 26 and thereafter into the attachment plate 100). In another embodiment, the attachment plate 100 may be electrically coupled to the battery 22 via corresponding electrical terminals (not shown). Hence, the battery 22 may be configured to selectively and simultaneously heat both the of the blade 26 and the attachment plate 100. The attachment plate 100 may comprise any desired shape and size. As shown in FIG. 5, the attachment plate 100 may comprise a trapezoidal cross-section, allowing snow or other material to easily travel thereover when entering or exiting the shovel head 24. In an alternative embodiment, the attachment plate 100 may be comprised of a non-conductive material, and thereby may not allow electrical current to flow therethrough. In an alternative embodiment, the attachment plate 100 may be mounted onto the shovel head 24 via a left and right pair of mounting brackets at the left and right side walls 48 of the shovel head 24.

In one embodiment, the blade 26 may have one or more detents 104, on its top, bottom, and/or end wall, and the blade compartment 60 may have corresponding detent recesses 106, within corresponding blade facing walls. Alternatively, the blade 26 may include detent recesses and the blade compartment 60 may include corresponding detents. In one embodiment, as shown in FIG. 5, the blade compartment 60 may comprise one or more detent recesses 106, extending inwardly into the bottom shelf 64, that receive corresponding detents 104 of the blade 26 which extend downwardly from the bottom of the blade 26. A detent force of the one or more detents 104 may secure the blade 26 onto the shovel head 24, in isolation or in combination with the attachment plate 100 and/or one or more blade fasteners (such as fasteners 28 as shown in FIG. 1). In one embodiment, each detent 104 may be spring biased. In another embodiment, each detent 104 may comprise a fixed and annular protrusion extending downwardly from the bottom of the blade 26. In one embodiment, the blade 26 may be a quick-disconnect blade 26 such that the user need only pull outwardly or push inwardly on the blade 26 to overcome the detent force acting against the blade compartment 60 to accordingly (dis)connect the blade 26. In another embodiment, to remove the blade 26, the user may first remove the attachment plate 100 and subsequently decouple the one or more detents 104 from the one or more detent recesses 106 of the blade compartment 60.

In one embodiment, as shown in FIGS. 4-5, the blade compartment 60 may be in the form of a multipart or multibody compartment 60. The multipart blade compartment 60 may comprise a top wall 108 formed by a bottom portion of the attachment plate 100, a bottom wall 110 formed by a top surface 110 of the horizontal bottom shelf 64 of the shovel head 24, and a vertical end wall 62 formed by the shovel head 24 which extends in between the top wall 108 and the bottom wall 110. The top wall 108, the bottom wall 110, and the end wall 62 may collectively define an open recess 60 within which the blade 26 can be removably seated.

In an alternative embodiment, the shovel head 24 may comprise an end wall with a rectangular recess or cutout which extends inwardly into the body of the shovel head 24 and which receives a portion of the blade 26 therein (not shown). In such an embodiment, the blade compartment 60 may be defined by the recess and the perimeter wall there surrounding which also fits over the blade 26 when the blade 26 is seated within the recess. In another alternative embodiment, the shovel head 24 may include multiple annular recesses or cutouts in its end wall which respectively receive corresponding annular protrusions extending rearwardly from the blade 26.

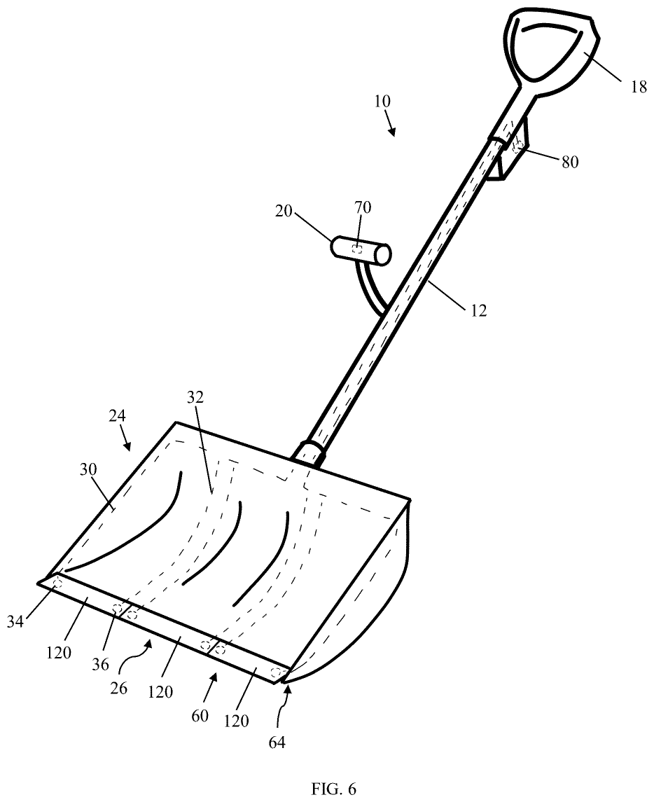

FIG. 6 illustrates another exemplary embodiment of a snow shovel 10. The snow shovel 10 may be substantially similar to the snow shovel 10 of FIGS. 1-2 as discussed above with a few exceptions or variations. In the embodiment shown, the snow shovel 10 includes a multipart blade 26 comprised of individual, smaller blade sections 120 respectively connected to the shovel head 24 via one or more fasteners (not shown). Each blade section 120 is electrically coupled to the battery 22 via respective electrical wiring, e.g., positive and negative lead wires 30, 32, and electrical terminals 34, 36 coupled thereto. As shown, each electrical terminal 34, 36 is located within the bottom shelf 64 of the shovel head 24. Thus, if one of the blade sections fail, the remaining blades can still heat the failed blade through conduction to maintain operability.

In one embodiment, the blade 26 discussed herein may be replaceable as desired. For example, as the blade 26 becomes dull or damaged during use thereof, the user may easily and quickly interchange the blade 26 with a new blade 26. For instance, as an example, the user may unfasten the fasteners 28, remove the blade 26, insert the new blade 26 into the blade compartment 60, and refasten the blade 26 onto the shovel head 24. Additionally, as another example, if the blade 26 is equipped with detents 104 which couple the blade 26 to the shovel head 24 (instead of fasteners 28), the user may simply pull the blade 26 out of the blade compartment 60 and insert the new blade 26 into the blade compartment 60.

Descriptions of technical features or aspects of an exemplary configuration of the disclosure should typically be considered as available and applicable to other similar features or aspects in another exemplary configuration of the disclosure. Accordingly, technical features described herein according to one exemplary configuration of the disclosure may be applicable to other exemplary configurations of the disclosure, and thus duplicative descriptions may be omitted herein.

Each memory can have stored thereon instructions that when executed by a hardware processor cause the hardware processor to perform several tasks, including access data files, analyze data files, perform analysis of the data files, and provide outputs indicative of characteristics or parameters represented by the data files. Each hardware processor may comprise any desired processor.

Methods of making and of using the snow shovel, and components thereof, are within the scope of the present invention.

Although limited embodiments of handle assemblies, and methods of operation thereof, have been specifically described and illustrated herein, many modifications and variations will be apparent to those skilled in the art. The disclosure is also defined in the following claims.

### EXAMPLE EMBODIMENTS

The following are numbered example embodiments of the apparatuses, devices, systems, and methods related to a snow shovel. The below listing of examples or any other examples disclosed herein may be combined in whole or in part. Elements of the examples disclosed herein are not limiting.

Example 1. A heated snow shovel including a shaft extending longitudinally from a proximal end to a distal end, a handle connected to the proximal end of the shaft, and a battery connected to the shaft. The heated snow shovel further including a shovel head connected to the distal end of the shaft, and a scraper blade removably connected to the shovel head and extending outwardly therefrom. The blade is eclectically coupled to the battery such that the blade is selectively heatable by the battery and configured to contact and heat snow.

Example 2. The heated snow shovel assembly, system, device, apparatus, and method of any of the above Examples alone or in combination, wherein the battery is configured to only heat the blade such that only the blade is configured to heat the snow.

Example 3. The heated snow shovel assembly, system, device, apparatus, and method of any of the above Examples alone or in combination, wherein the shovel head comprises a non-conductive material.

Example 4. The heated snow shovel assembly, system, device, apparatus, and method of any of the above Examples alone or in combination, wherein the blade comprises a conductive material, allowing the blade to become heated upon receiving electrical power from the battery.

Example 5. The heated snow shovel assembly, system, device, apparatus, and method of any of the above Examples alone or in combination, wherein the snow shovel further includes a blade compartment at a distal end of the shovel head and a first and a second terminal respectively mounted on opposing sides of the blade compartment. The snow shovel further includes electrical wiring extending in between the battery and the first and second terminals. The blade automatically contacts the first and second terminals, and therewith becomes electrically coupled to the battery, upon being seated within the blade compartment.

Example 6. The heated snow shovel assembly, system, device, apparatus, and method of any of the above Examples alone or in combination, wherein each electrical terminal applies a holding force onto the blade to secure the blade onto the shovel head.

Example 7. The heated snow shovel assembly, system, device, apparatus, and method of any of the above Examples alone or in combination, wherein each electrical comprises a metallic receptacle, leaf spring, prongs, or other contact point.

Example 8. The heated snow shovel assembly, system, device, apparatus, and method of any of the above Examples alone or in combination, wherein the shovel head comprises a blade compartment at a distal end thereof, and the blade is seated within the blade compartment such that a top surface of the blade is substantially flush with a top surface the shovel head.

Example 9. The heated snow shovel assembly, system, device, apparatus, and method of any of the above Examples alone or in combination, wherein the blade compartment of the shovel head comprises a vertical end wall and a shelf extending outwardly and substantially perpendicularly from the end wall which is configured to at least partially support the blade when the blade is seated within the blade compartment.

Example 10. The heated snow shovel assembly, system, device, apparatus, and method of any of the above Examples alone or in combination, wherein the shovel head comprises a multipart blade compartment at a distal end thereof.

Example 11. The heated snow shovel assembly, system, device, apparatus, and method of any of the above Examples alone or in combination, wherein the multipart blade compartment comprises a top wall, a bottom wall, and a vertical end wall extending in between the top wall and the bottom wall. The top wall, the bottom wall, and the end wall collectively define an open recess within which the blade is removably seated.

Example 12. The heated snow shovel assembly, system, device, apparatus, and method of any of the above Examples alone or in combination, wherein the blade comprises one or more detents. The blade compartment comprises one or more detent recesses corresponding to the one or more detents of the blade.

Example 13. The heated snow shovel assembly, system, device, apparatus, and method of any of the above Examples alone or in combination, wherein the one or more detents allow the blade to be removable merely upon pulling outwardly on the blade to overcome a detent force of the one or more detents acting against the blade compartment.

Example 14. The heated snow shovel assembly, system, device, apparatus, and method of any of the above Examples alone or in combination, wherein the one or more detent recesses extend into the bottom shelf of the blade compartment of the shovel head.

Example 15. The heated snow shovel assembly, system, device, apparatus, and method of any of the above Examples alone or in combination, wherein the snow shovel further includes an attachment plate connected to the shovel head and electrically coupled to the battery. The attachment plate is configured to at least partially extend over and secure the blade onto the shovel head.

Example 16. The heated snow shovel assembly, system, device, apparatus, and method of any of the above Examples alone or in combination, wherein the battery is configured to selectively and simultaneously heat both the of the blade and the attachment plate.

Example 17. The heated snow shovel assembly, system, device, apparatus, and method of any of the above Examples alone or in combination, wherein the attachment plate comprises an isosceles trapezoidal cross-section.

Example 18. The heated snow shovel assembly, system, device, apparatus, and method of any of the above Examples alone or in combination, wherein the blade comprises a multipart blade including two or more individually heated sections removably connected to the shovel head.

Example 19. The heated snow shovel assembly, system, device, apparatus, and method of any of the above Examples alone or in combination, wherein the blade is electrically coupled to the battery via electrical wires internally disposed within the handle and the shovel head.

Example 20. The heated snow shovel assembly, system, device, apparatus, and method of any of the above Examples alone or in combination, wherein the snow shovel further includes a user input device connected to the shaft and electrically coupled to the battery. The user input device is configured to receive user input to selectively provide electrical power from the battery to the blade for heating the blade.

Example 21. The heated snow shovel assembly, system, device, apparatus, and method of any of the above Examples alone or in combination, wherein the user input device comprises a mechanical switch, a dial, a button, and/or a display screen.

Example 22. The heated snow shovel assembly, system, device, apparatus, and method of any of the above Examples alone or in combination, wherein the snow shovel further includes a control unit. The control unit is configured to automatically heat and/or maintain a desired temperature of the blade.

Example 23. The heated snow shovel assembly, system, device, apparatus, and method of any of the above Examples alone or in combination, wherein the control unit includes a controller, a timer, and/or one or more sensors for sensing a temperature of the blade.

Example 24. The heated snow shovel assembly, system, device, apparatus, and method of any of the above Examples alone or in combination, wherein the one or more sensors include a temperature sensor mounted on the shovel head and configured to sense a temperature of the blade.

Example 25. The heated snow shovel assembly, system, device, apparatus, and method of any of the above Examples alone or in combination, wherein the battery is connected to the shaft next to the first handle at the proximal end of the shaft, counterbalancing a weight of the shovel head.

Example 26. The heated snow shovel assembly, system, device, apparatus, and method of any of the above Examples alone or in combination, wherein the battery includes a lithium ion battery.

Example 27. The heated snow shovel assembly, system, device, apparatus, and method of any of the above Examples alone or in combination, wherein the blade is substantially rectangular with a tapered edge.

Example 28. The heated snow shovel assembly, system, device, apparatus, and method of any of the above Examples alone or in combination, wherein the blade is comprised of a single conductive material.

Example 29. The heated snow shovel assembly, system, device, apparatus, and method of any of the above Examples alone or in combination, wherein the blade is comprised of two or more materials, including at least one conductive material.

Example 30. The heated snow shovel assembly, system, device, apparatus, and method of any of the above Examples alone or in combination, wherein the blade comprises an outer steel portion and an inner nichrome portion.

Example 31. The heated snow shovel assembly, system, device, apparatus, and method of any of the above Examples alone or in combination, wherein the blade comprises a steel shell and a nichrome core disposed within the steel shell.

Example 32. A snow shovel including a shaft, a heating device, a shovel head connected to the shaft, and a scraper blade removably connected to the shovel head and extending outwardly therefrom. The blade is eclectically coupled to the heating device such that the blade is selectively heatable by the heating device and configured to contact and heat snow.

Example 33. The heated snow shovel assembly, system, device, apparatus, and method of any of the above Examples alone or in combination, wherein the snow shovel further includes a first handle connected to the shaft at a proximal end thereof and a second handle connected to the shaft at an approximate midpoint thereof. The first handle and/or the second handle comprise a user input device mounted thereon and which is operably coupled to the heating device.

Example 34. The heated snow shovel assembly, system, device, apparatus, and method of any of the above Examples alone or in combination, wherein the heating device comprises a battery configured to electrically heat the blade.

Example 35. A method of making a snow shovel, including forming a snow shovel. The snow shovel is configured to heat snow. The snow shovel includes a shaft, a heating device, a shovel head connected to the shaft, and a scraper blade removably connected to the shovel head and extending outwardly therefrom. The blade is eclectically coupled to the heating device. The heating device is configured to only heat the blade so that only the blade is configured to heat the snow.

Example 36. The heated snow shovel assembly, system, device, apparatus, and method of any of the above Examples alone or in combination, wherein the method further includes a step of replacing the blade by decoupling the blade from a blade compartment of the shovel head and inserting a differing second blade into the blade compartment. The second blade is automatically electrically coupled to the heating device upon insertion into the blade compartment.

Example 37. A snow shovel comprising: a shaft extending longitudinally from a proximal end to a distal end; a handle connected to the shaft; a battery connected to the shaft; a shovel head connected to the distal end of the shaft, the shovel head comprising a body and a distal edge; and a scraper blade removably connected to the shovel head and extending outwardly of the distal edge of the body, the scraper blade eclectically coupled to the battery such that the blade is selectively heatable by electrical power produced by the battery.

Example 38. A snow shovel comprising: a shaft having a lengthwise axis extending between a proximal end and a distal end; a handle connected to the shaft; a battery connected to the shaft; a shovel head connected to the shaft, the shovel head comprising a body and a distal edge; and a scraper blade removably connected to the shovel head and extending outwardly of the distal edge of the body, the scraper blade being fastened to the body and is eclectically coupled to the battery such that the blade is selectively heatable by electrical power produced by the battery.

Example 39. The scraper blade can be formed from two separate blade sections having a non-continuous seam therebetween.

Example 40. The scraper blade can have a tapered edge.

Example 41. The scraper blade can be electrically connected to the battery through one or more springs.

Example 42. Electric flow from the battery to the scraper blade can vary by a potentiometer.

Example 43. The shaft can have a battery mount mounted thereon, the battery mount can have electrical contacts for contacting with anode and cathode terminals on the battery.

Example 44. The battery is insertable and removable from the battery mount.

Example 45. The battery can have a movable latch for latching to the battery mount.

Example 46. The battery mount can have an indicator for indicating a charge level of the battery.

Example 47. A blade compartment can be secured to the body of the shovel head, the blade compartment can have a shelf for supporting the scraper blade and can have a threaded bore for receiving a fastener.

Example 48. The scraper blade can be positioned in the blade compartment and rests on the shelf.

Example 49. The scraper blade can have a blade edge and the blade edge can extend outwardly from a distal edge of the blade compartment.

Example 50. The body of the shovel head is made from plastic or engineered plastic.

Example 51. The body of the shovel head is made from a metal material.

Example 52. The body can have a distal edge and the blade edge can extend distally of the distal edge of the body.

Example 53. The tip of the blade edge can be the distal-most structure located on the snow shovel.

Example 54. The scraper blade can have a working edge or distal edge for shoveling into the ice or snow, and two side edges located laterally of the working edge. The two side edges can extend towards the sidewalls of the shovel head, and preferably contact or close to contacting the two sidewalls of the shovel head.

What is claimed is:

1. A snow shovel comprising:
a shaft extending longitudinally from a proximal end to a distal end;
a handle connected to the shaft;
a battery connected to the shaft;
a shovel head connected to the distal end of the shaft, the shovel head comprising a body and a distal edge; and
a scraper blade removably connected to the shovel head and extending outwardly of the distal edge of the body, the scraper blade eclectically coupled to the battery such that the blade is selectively heatable by electrical power produced by the battery.

2. The snow shovel of claim 1, wherein the battery is configured to only heat the blade such that only the blade is configured to heat snow when the snow shovel is used to shovel the snow.

3. The snow shovel of claim 1, wherein:
the shovel head comprises a non-conductive material; and
the blade comprises a conductive material, allowing the blade to become heated upon receiving electrical power from the battery.

4. The snow shovel of claim 1, further comprising:
a blade compartment at a distal end of the shovel head;
a first and a second terminal respectively mounted on opposing sides of the blade compartment; and
electrical wiring extending in between the battery and the first and second terminals,
wherein the blade automatically contacts the first and second terminals, and therewith becomes electrically coupled to the battery, upon being seated within the blade compartment.

5. The snow shovel of claim 1, wherein:
the shovel head comprises a blade compartment at a distal end thereof; and
the blade is seated within the blade compartment such that a top surface of the blade is substantially flush with a top surface the shovel head.

6. The shovel of claim 5, wherein the blade compartment of the shovel head comprises a vertical end wall and a shelf extending outwardly and substantially perpendicularly from the end wall which is configured to at least partially support the blade when the blade is seated within the blade compartment.

7. The shovel of claim 1, wherein:
the shovel head comprises a multipart blade compartment at a distal end thereof;
the multipart blade compartment comprises a top wall, a bottom wall, and a vertical end wall extending in between the top wall and the bottom wall; and
the top wall, the bottom wall, and the end wall collectively define an open recess within which the blade is removably seated.

8. The shovel of claim 7, wherein:
the blade comprises one or more detents; and
the blade compartment comprises one or more detent recesses corresponding to the one or more detents of the blade, allowing the blade to be removable upon pulling outwardly on the blade to overcome a detent force of the one or more detents acting against the blade compartment.

9. The snow shovel of claim 1, further comprising an attachment plate connected to the shovel head and electrically coupled to the battery, the attachment plate configured to at least partially extend over and secure the blade onto the shovel head, wherein the battery is configured to selectively and simultaneously heat both the of the blade and the attachment plate.

10. The snow shovel of claim 1, wherein the blade comprises a steel shell and a nichrome core disposed within the steel shell.

11. The snow shovel of claim 1, wherein the blade comprises a multipart blade including two or more individually heated sections removably connected to the shovel head.

12. The snow shovel of claim 1, further comprising a user input device connected to the shaft and operably coupled to the battery, the user input device configured to receive user input to selectively provide electrical power from the battery to the blade for heating the blade.

13. A snow shovel comprising:
a shaft;
a heating device;
a shovel head connected to the shaft; and
a scraper blade removably connected to the shovel head and extending outwardly therefrom, the blade eclectically coupled to the heating device such that the blade is selectively heatable by the heating device and configured to contact and heat snow.

14. The snow shovel of claim 13, further comprising:
a first handle connected to the shaft at a proximal end thereof; and
a second handle connected to the shaft at an approximate midpoint thereof,
wherein the first handle and/or the second handle comprise a user input device mounted thereon and which is operably coupled to the heating device.

15. The snow shovel of claim 13, wherein the heating device comprises a battery configured to electrically heat the blade.

16. The snow shovel of claim 13, wherein the heating device is configured to only heat the blade such that only the blade is configured to heat the snow.

17. The snow shovel of claim 13, wherein:
the shovel head comprises a blade compartment at a distal end thereof; and
the blade is seated within the blade compartment such that a top surface of the blade is substantially flush with a top surface the shovel head.

18. The shovel of claim 13, wherein:
the shovel head comprises a blade compartment at a distal end thereof; and
the blade compartment comprising a top wall, a bottom wall, and a side wall extending in between the top wall and the bottom wall, the top, bottom, and side walls defining an open recess within which the blade is removably seated.

19. A method comprising:
forming a snow shovel configured to heat snow, the snow shovel including a shaft, a heating device, a shovel head connected to the shaft, and a scraper blade removably connected to the shovel head and extending outwardly therefrom, the blade eclectically coupled to the heating device,
wherein the heating device is configured to only heat the blade so that only the blade is configured to heat the snow.

20. The method of claim 19, wherein:
the shovel head comprises a blade compartment for receiving the blade therein; and
the method further comprises a step of replacing the blade by decoupling the blade from the blade compartment and inserting a differing second blade into the blade compartment, wherein the second blade is automatically electrically coupled to the heating device upon insertion into the blade compartment.
